(19) United States
(12) Patent Application Publication
(10) Pub. No.: US 2018/0199586 A1
(43) Pub. Date: Jul. 19, 2018

(54) CONVENTIONAL OR REDUCED-CALORIE FILLED OR UNFILLED VITAMIN-ENRICHED CHOCOLATE AND PROCESS FOR THE PRODUCTION THEREOF

(71) Applicant: Vita Choco Kft., Tokaj (HU)

(72) Inventor: Rudolf BÁNÁTFY, Budapest (HU)

(21) Appl. No.: 15/743,660

(22) PCT Filed: Jul. 8, 2016
(86) PCT No.: PCT/HU2016/000046

§ 371 Date: Jan. 10, 2018

(30) Foreign Application Priority Data
Jul. 10, 2015 (HU) P1500321

(51) Int. Cl. A23G 1/42; A23G 1/32

(52) U.S. Cl. CPC A23G 1/426; A23V 2002/00; A23G 1/32; A23G 1/325

(57) ABSTRACT

The invention pertains to a conventional or reduced-calorie, filled or unfilled, vitamin-enriched type of chocolate characterised in that 100 g of product contains at least 5-1500 mg of added calcium ascorbate and/or magnesium ascorbate and/or ascorbic acid or, in some cases, other supplementary ingredients. The other supplementary ingredients are additional vitamins, such as E and/or K, as well as mineral materials, preferably magnesium and/or zinc, along with fruit concentrates. The invention also pertains to the process by which the vitamin-enriched chocolate is produced.

This invention pertains to a conventional or reduced-calorie, filled or unfilled, vitamin-enriched type of chocolate and the process by which it is produced, characterised in that the mass of chocolate prepared using the usual process contains added vitamin C and/or other supplementary ingredients. The invention also pertains to the production of said vitamin-enriched chocolate.

The usefulness of chocolate has been discussed in an increasing number of scientific articles, for which reason it is, today, not only a luxury, but also, increasingly, a complex part of the modern lifestyle.

No similar product, that is, no chocolate enriched with added vitamins, is currently known on the market, despite the ever-broadening, increasingly interesting selection of flavours, which indeed, does not serve this particular purpose. Some specifications have noted vitamin C (and other vitamin) content as one of a chocolate product's beneficial properties, but these always refer to the natural vitamin content of cocoa and other ingredients (as with other grocery products), and this cannot be evaluated as a source of vitamins. A distantly “related product” is to be found in vitamin C enriched candies (sweets), but these do not compare to the chocolate products according to this invention in terms of vitamin content, enjoyment value, or any other intrinsic characteristic.

Representing prior art with regard to the present invention is U.S. Pat. No. 3,697,641 (A), pertaining to a novel non-hygroscopic, non-sugarbase, non-cariogenic, 1-ascorbic acid, vitamin c, releasable base material for use in the preparation of suckable tablets, lozenges, and chocolate, either alone, or in conjunction with suitable other desired additions, such as flavouring-, medical-, antimicrobial-, sweetening, colouring agents and the like, and including agents generally employed in the art of tablet, lozenge, and chocolate making, and vitamins, and specifically relates to compositions of the novel base material formed by compounding calcium ascorbate dihydrate alone or in admixture with dibasic magnesium phosphate with solid glycerides of the selfemulsifying type derived from at least one of the group including edible fats; oils; and edible fat-forming fatty acids.

In creating the present invention, our objective was to supplement chocolate with extra properties, such as added vitamins, minerals, and other healthy ingredients, achieving an even broader customer/consumer base, thus offering chocolate consumers an even more various and, at the same time, healthier chocolate product alternative. Another objective was that the added vitamin C not make the confection taste sour.

The present invention is based on the realisation that two familiar product categories might be combined into a single product: chocolate, as a grocery product, and nutritional supplements, such that the latter affects neither the taste of the chocolate, nor any other property related to its enjoyability. Because the expression “2 in 1” is well known among both manufacturers and consumers, we believe that the present invention represents an optimal solution. Although vitamin C is one of the most easily marketable and attractive nutritional supplements, its taste renders it unsuitable for use in chocolate making. With this as with other vitamins and minerals, it was necessary to find a solution that prevented the chocolate from losing value as a luxury article. For all practical purposes, what we have created is a novel type of product or family of products that, to our knowledge, is at present absent from the market.

The inventive step in my solution was that the chocolate not have a sour, bitter, or otherwise intrusive taste, an achievement reached partly through vitamin C analogues, and partly through a recipe that may be regarded as a novelty in this invention; that is, we use a formula for ascorbic acid that ensures that it does not dissolve in the product and later is released over a longer period of time—in contrast to other grocery products with added vitamin C; in addition, the product line has been made to include other vitamins and essential elements.

Thus, the subject of this invention is a conventional or reduced-calorie, vitamin-enriched type of chocolate, in which at least 5-1500 mg of calcium ascorbate and/or magnesium ascorbate and/or ascorbic acid, or in some cases other supplementary ingredients, are added to each 100 g of chocolate mass. The sugar content of the chocolate is set using natural and/or reduced-calorie sweeteners, such as fructose, xylose, stevia, inulin, maltitol, erythritol, etc. The other supplementary ingredients include further vitamins and/or minerals and/or fruit concentrates. Other vitamins used include vitamins E and/or K, while other minerals include Ca and/or Mg and/or Zn.

The invention also pertains to the process for producing the above vitamin-enriched chocolate, where, following the preparation of a mass of chocolate of the appropriate combination of tastes, a mix containing the added vitamin C and/or minerals and/or supplementary ingredients is made, and, after grinding it to the appropriate grain size, the mass and vitamin mix are combined until homogenous, avoiding overheating and changes in consistency, within a strictly maintained narrow temperature range, via what is known as gradual cooling.

With the recipes presented below, it is clear that the this technology can be applied to the widest variety of chocolates, including dark, milk, white, filled, and unfilled chocolates, each in conventional and reduced-calorie varieties, and, naturally, to combinations of these, as well, as demonstrated by the following examples.

The first example offers a recipe for convention and reduced-calorie milk chocolate.

### EXAMPLE 1

| | Conventional milk | | Reduced-calorie | |
|---|---|---|---|---|
| | chocolate with | | milk chocolate with | |
| | added vitamins | | added vitamins | |
| | g/100 g | | g/100 g | |
| ingredient/100 g | “A” | “B” | “A” | “B” |
| fat | 35 | 36.3 | 35 | 36.3 |
| carbohydrates | 53.5 | 49.7 | 35 | 30 |
| protein | 8.7 | 7.4 | 8.7 | 7.4 |
| salt | 0.313 | 0.17 | 0.313 | 0.17 |
| calcium ascorbate | 0.15 | 0.3 | 0.12 | 0.25 |
| ascorbic acid | 0.008 | 0.01 | 0.008 | 0.01 |
| stevia extract | | | 10 | |
| xylitol | | | | 15 |
| fruit concentrate | | | | |
| minimum content of: | % | | % | |
| dry cocoa | 30 | 32 | 30 | 32 |
| dry milk | 33 | 32 | 33 | 32 |
| calories kcal | 566 | 562 | 386 | 384 |

Similarly, the second example offers a recipe for dark chocolate.

### EXAMPLE 2

| | conventional dark | | reduced-calorie | |
|---|---|---|---|---|
| | chocolate with | | dark chocolate with | |
| | added vitamins | | added vitamins | |
| | g/100 g | | g/100 g | |
| ingredient/100 g | “A” | “B” | “A” | “B” |
| fat | 33 | 35 | 33 | 35 |
| carbohydrates | 52 | 48 | 32 | 35 |
| protein | | | | |
| salt | 0.2 | 0.22 | 0.2 | 0.22 |
| calcum ascorbate | 0.5 | 0.6 | 0.4 | 0.5 |
| ascorbic acid | 0.008 | 0.01 | 0.008 | 0.01 |
| stevia extract | | | 14 | |
| xylitol | | | | 17 |
| fruit concentrate | | | | |
| minimum content of: | | | | |
| dry cocoa | 40 | 60 | 40 | 60 |
| dry milk | | | | |
| calories kcal | 575 | 588 | 372 | 378 |

The third example offers a recipe for white chocolate.

### EXAMPLE 3

| | conventional white | | reduced-calorie | |
|---|---|---|---|---|
| | chocolate with | | white chocolate with | |
| | added vitamins | | added vitamins | |
| | g/100 g | | g/100 g | |
| ingredient/100 g | “A” | “B” | “A” | “B” |
| fat | 35 | 37 | 33 | 33 |
| carbohydrates | 51.5 | 53 | 31 | 30 |
| protein | 8.8 | 9.2 | 8.9 | 9.1 |
| salt | 0.18 | 0.2 | 0.19 | 0.2 |
| calcium ascorbate | 0.2 | 0.4 | 0.18 | 0.35 |
| ascorbic acid | 0.008 | 0.01 | 0.008 | 0.01 |
| stevia extract | | | 15 | |
| xylitol | | | | 17 |
| fruit concentrate | | | | |
| minimum content of: | | | | |
| dry cocoa | | | | |
| dry milk | 30 | 35 | 33 | 32 |
| calories kcal | 579 | 582 | 391 | 378 |

The fourth example offers a recipe for filled dark chocolate

### EXAMPLE 4

| | | | reduced-calorie | |
|---|---|---|---|---|
| | filled dark chocolate | | filled dark chocolate | |
| | with added vitamins | | with added vitamins | |
| | g/100 g | | g/100 g | |
| ingredient/100 g | “A” | “B” | “A” | “B” |
| fat | 33 | 33 | 33 | 33 |
| carbohydrates | 49 | 49 | 31 | 31 |
| protein | | | | |
| salt | 0.2 | 0.22 | 0.2 | 0.22 |
| calcium ascorbate | 0.05 | 0.05 | 0.05 | 0.05 |
| ascorbic acid | 1.2 | 1.5 | 1.2 | 1.5 |
| stevia extract | | | 11 | |
| xylitol | | | | 14 |
| fruit concentrate | 16 | 16 | 20 | 20 |
| minimum content of: | | | | |
| dry cocoa | 40 | 60 | 45 | 45 |
| dry milk | | | | |
| calories kcal | 595 | 620 | 411 | 414 |

The fifth example offers a recipe for filled milk chocolate

### EXAMPLE 5

| | | | reduced-calorie | |
|---|---|---|---|---|
| | filled white chocolate | | filled white chocolate | |
| | with added vitamins | | with added vitamins | |
| | g/100 g | | g/100 g | |
| ingredient/100 g | “A” | “B” | “A” | “B” |
| fat | 31 | 31 | 31 | 31 |
| carbohydrates | 50 | 50 | 31 | 31 |
| protein | | | | |
| salt | 0.2 | 0.22 | 0.21 | 0.21 |
| calcium ascorbate | 0.05 | 0.05 | 0.05 | 0.05 |
| ascorbic acid | 1.2 | 1.5 | 1.2 | 1.5 |
| stevia extract | | | 15 | |
| xylitol | | | | 16 |
| fruit concentrate | 17 | 17 | 21 | 20 |
| minimum content of: | | | | |
| dry cocoa | | | | |
| dry milk | 33 | 35 | 33 | 35 |
| calories kcal | 603 | 611 | 402 | 403 |

Example 1 clearly shows that the components of the known base material are carbohydrates, fat, protein, and salt, to which 0.15 to 0.3 g of calcium ascorbate and 0.008 to 0.01 g of ascorbic acid, or in the case of the reduced-calorie version, 10 g of stevia extract and 15 g of xylitol, have been added as supplements.

A similar process is used for the other types of chocolate, such that for filled types, 17-21 g of fruit concentrate is also added to the filling as an additional supplementary ingredient.

For devising the best recipe, our first task was to find those vitamins and essential components that can be mixed with chocolate types of different flavours and compositions. Fundamentally necessary components: ascorbic acid, calcium ascorbate, magnesium ascorbate. Quantities: 5mg-1500 mg/100 g of product, either altogether, or individually. Also usable as supplementary components are fructose, xylose, erythritol, maltitol, inulin, stevia extract, vitamins E and K, calcium, magnesium, zinc or even, in some cases, fruit concentrate.

Some of the ingredients in the recipes, such as the non-sugar sweeteners xylose and stevia, can be found in what are termed “special chocolates”. The use of calcium, magnesium, and zinc in the present recipes is wholly absent from the market.

The recipes in the present patent have been included as examples, though the technology itself features novelties to which here we make mere reference:
Preparation of the appropriate flavour combination of chocolate;
Preparation of a mix of vitamin and/or vitamin-mineral material, ground to the appropriate grain size, while avoiding overheating and any change in consistency (according to technology);
Combination of the chocolate mass and the vitamin mix until homogenous (according to the latest technology);
Preparation of individual portions, cooling according to parameters set via experimentation (according to the latest technology);
The chocolate, whose manufacture requires the application of heat within a strictly maintained range of temperatures, is made using a novel process called gradual cooling (applied when mixing its components) due to the stability/instability of the vitamin C.

At present, the preparation, grinding, and mixing of the vitamins and minerals is done using simple means, by hand. For large-scale manufacture, such means may be replaced with the appropriate mixing equipment.

The base product is chocolate, the steps of whose manufacture are known, and in which matter we have no wish to innovate. At the same time, the added materials that form the essential part of our invention change the taste, consistency, lustre, etc. of the chocolate, the solutions to which problems required experimentation, the specification of material norms, the development of an appropriate means of mixing ingredients, in the proper order, etc., that is, the development of a recipe and specification of the steps involved in product manufacture, which we believe our invention alone possesses.

Thus, our invention as met the objectives set as per the foregoing, its benefits being as follows:
Given that the invention is a grocery product, its benefits are primarily of a nutritional biological nature. For a long time, chocolate stood as a symbol of sweet temptation; today, however, an increasing number of beneficial biological effects are attributed to it. It is to these effects that we have added via supplements of proven effectiveness and biological usefulness, potentially giving rise to a new product segment and a fashionable product associated with a healthy lifestyle.

### Economic Benefit

The new line of products falls into two different categories of merchandise, representing total revenues in Hungary of approximately 85 billion HUF/yr., and in the global market of approximately 100 billion Euro/yr. The global trend is toward increased trade in chocolate and nutritional supplements (e.g. it was reported not long ago that U.K. scientists had developed a type of chocolate that retarded the aging of the skin!), thus, once brought to market, the popularity of this invention could grow rapidly for reasons that include that it gives the consumer two products in one for a more economical price. This observation suggests that further product development (active research and development) would be worthwhile to increase turnover at every link along the chain of commerce, to create jobs at manufacturers, and to provide the consumer with a more valuable product for his/her money.

### Broad Range of Application

The invention is useful primarily in countries where day-to-day existence is not the major issue, where chocolate is an affordable treat that people use to bring a little joy to their day or give as a small gift to others. Most consumers like practical things, so if something is both delicious, and useful, it will be more likely to be purchased by people who worry about their weight than if it were just something they desired to eat. The product would be a boon to children (perhaps even more so to parents), as they would no longer have to take nutritional tablets (which are hard for many children to swallow and some children even refuse to take), problems which are partly resolved by our invention. The product would also be an “aid” to sports persons, students studying for exams, hikers, and all others who are exposed to relatively great mental or physical stress. Conscious shoppers will look for it specifically and will pass the news on to others.

1. A conventional or reduced-calorie, vitamin-enriched type of chocolate, characterised in that each 100 g of chocolate mass contains at least 5-1500 mg of added calcium ascorbate and/or magnesium ascorbate and/or ascorbic acid, or in some cases, other supplementary ingredients.

2. The vitamin-enriched type of chocolate according to claim 1, characterised in that the sugar-content of the chocolate is set using natural and/or reduced-calorie sweeteners such as fructose, xylose, stevia, inulin, maltitol, erythritol, etc.

3. The vitamin-enriched type of chocolate according to either of claims 1 characterised in that the other supplementary ingredients are additional vitamins and/or minerals and/or fruit concentrate.

4. The vitamin-enriched type of chocolate according to claim 3 characterised in that the additional vitamins are vitamins E and/or K.

5. The vitamin-enriched type of chocolate according to claim 3 characterised in that the minerals are calcium and/or magnesium and/or zinc.

6. A process for the production of the vitamin-enriched type of chocolate according to claim 1 characterised in that, after a mass of chocolate of the appropriate flavour combination is prepared, an added vitamin C and/or mineral material and/or a mixture containing supplementary ingredients is prepared and ground to the appropriate grain size and the mass and the vitamin mix are combined until homogenous, such that overheating and changes in consistency are avoided, using a process of “gradual cooling” that takes place within a strictly maintained range of temperatures.
